(19) United States
(12) Patent Application Publication
(10) Pub. No.: US 2009/0198351 A1
(43) Pub. Date: Aug. 6, 2009

(54) Control circuit and camera apparatus

(75) Inventor: Koji Kitagawa, Kanagawa (JP)

Correspondence Address: RADER FISHMAN & GRAUER PLLC, LION BUILDING, 1233 20TH STREET N.W., SUITE 501, WASHINGTON, DC, 20036, US

(73) Assignee: Sony Corporation, Tokyo (JP)

(21) Appl. No.: 12/318,782

(22) Filed: Jan. 8, 2009

(30) Foreign Application Priority Data
Feb. 5, 2008 (JP) 2008-025665

(51) Int. Cl. G05B 13/02

(52) U.S. Cl. 700/42

(57) ABSTRACT

A control circuit includes a desired value arithmetic unit that calculates a desired value of a control object, a sensor that detects a value indicating a state of an actuator used to displace the control object, a deviation arithmetic unit that calculates a deviation of the control object from the desired value, a proportional arithmetic unit that produces a proportional-component drive signal, an integral arithmetic unit that calculates an integral value of the deviation and produces an integral-component drive signal, a derivative arithmetic unit that calculates a derivative value of the deviation and produces a derivative-component drive signal, and a drive-signal output unit that outputs the drive signals provided from the integral arithmetic unit, the proportional arithmetic unit, and the derivative arithmetic unit to a drive circuit for the actuator. At least the integral gain ki of the integral arithmetic unit is in a range 0.1 V/rad·s≦ki≦4200 V/rad·s.

### CROSS REFERENCES TO RELATED APPLICATIONS

The present invention contains subject matter related to Japanese Patent Application JP 2008-025665 filed in the Japanese Patent Office on Feb. 5, 2008, the entire contents of which are incorporated herein by reference.

### BACKGROUND OF THE INVENTION

1. Field of the Invention

The present invention relates to a control circuit that is suitable for application to light-load control of, for example, an iris and a neutral density (ND) filter for a camcorder and a still camera, and to a camera apparatus.

2. Description of the Related Art

In recent years, VCR integrated video cameras and still cameras (collectively called cameras) have been reduced in size and weight in accordance with an increase in the density with which their various components are packaged. In line with this trend of reduction in size and weight of cameras, image pickup devices have also been reduced in size and weight. Examples of such devices include an iris (diaphragm blade) for controlling the amount of light and an ND filter for attenuating light. When an iris itself becomes smaller, for example, the amount of light changes more sensitively to the amount of the movement of the iris, and therefore, smoother movement of the iris becomes necessary.

A typical existing light-load control system configured for controlling an object like an iris or an ND filter is a feedback control system that determines a control amount for a control object on the basis of an error between a detected value and a desired value, using proportional-integral-derivative (PID) control.

The diaphragm blades of an iris or an ND filter, though light in weight, have wide mutually contacting areas, and therefore, a large coefficient of static friction, generating a large load when the blades are to be moved from their state of rest. There is also friction generated between a rotating spindle and its bearing. Furthermore, when a meter (actuator) for moving the blades of an iris or an ND filter utilizes force of a magnetic spring, the meter operates in such a manner as to counteract the force exerted by the magnetic spring in accordance with a drive signal provided.

For instance, Japanese Unexamined Patent Application Publication No. 2003-29315 discloses a technology that allows smooth control of a control object by making the control object continue minute vibration without going into a state of rest, through superimposing a minute-amplitude alternating signal onto a drive signal, provided to an actuator, for driving the control object.

### SUMMARY OF THE INVENTION

Generally, a large loop gain, while allowing high-speed control of an object, will cause large overshoot and oscillation of the feedback control system, making the system unstable. In other words, the system oscillates around a desired value. On the other hand, a small loop gain, while making the system stable, results in a longer time before the system becomes stable and causes so-called stick-slip motion. The stick-slip motion is a phenomenon in which a control object unfavorably stops and moves due to friction between the control object and a sliding surface. This phenomenon, when it occurs during control of an iris or an ND filter, causes an unfavorable stepwise change in the amount of light projected onto an image pickup element. Hence, assigning an appropriate value to the loop gain of the feedback control system is necessary to achieve appropriate operation of the control object.

For instance, in the integral component of a feedback signal used in existing PID control, when a detected value deviates from a desired value, only (integral gain)×(constant voltage) is added for a certain length of time as an amount of control. Hence, as shown in FIG. 1, a gain for low frequencies of, for example, 50 Hz or less was not sufficiently large. The insufficient gain in such a low-frequency region causes several problems regarding friction, such as image fluctuation (jitter) and a stick-slip phenomenon, i.e., the amount of light projected onto an image pickup element unfavorably changes stepwise. These problems are observed especially in a light-load control object such as an iris or an ND filter.

FIG. 2 schematically illustrates a mechanism of jitter. The upper schematic diagram shows that an arm 101 coupled with the rotation spindle of an actuator is in a valley having walls of torque 102. The lower schematic diagram shows the jitter of the arm 101.

In the lower left portion of FIG. 2, since the integral of deviation of the arm 101 from a desired value is within a tolerance of an integral target, a voltage applied to the drive circuit of the actuator based on the integral operation is substantially zero volts (the first state). The upper portion of FIG. 2 corresponds to this first state, in which the control system is stable.

A drive signal for electrically generating force that balances a friction load and force exerted by a magnetic spring is supplied to the actuator for displacing the arm 101. When the friction load of the arm 101 decreases from this state due to dithering caused by electric noise or mechanical vibration, the arm 101 starts to move in the direction of force exerted by the magnetic spring. When a deviation (for example, several micrometers) from a target position is generated and exceeds a target tolerance (dead zone corresponding to an integral target tolerance), servo control performed by an integral component operates to apply a voltage to the drive circuit of the actuator that works to push back the arm 101 (the second state, the lower right portion of FIG. 2). Such an operation cycle sometimes repeats at a low frequency such as 5 Hz. When an iris or an ND filter undergoes this slow oscillation, the amount of light fluctuates, causing an image to cyclically become bright and then dark.

Hence, to realize an appropriate operation of a control object in a low-frequency region, it is necessary to assign appropriate values to the closed loop gains of the feedback control system, i.e., a proportional (P) operation gain, an integral (I) operation gain, and a derivative (D) operation gain in the PID control. However, the present inventor could not find any document that describes numerical analysis of a proportional operation gain, an integral operation gain, and a derivative operation gain in the PID control regarding a light-load control system for objects such as an iris or an ND filter.

The present invention addresses the above-identified problems. In a light-load control system for objects such as an iris or an ND filter, it is desirable to realize a control system in which a slow oscillation is suppressed in a low-frequency region by appropriately setting parameters such as an integral gain.

A control circuit according to an embodiment of the invention includes a desired-value arithmetic unit configured to calculate a desired value of a control object, a sensor configured to detect a value indicating a state of an actuator that is used to displace the control object, a deviation arithmetic unit configured to calculate a deviation of the control object from the desired value on the basis of the desired value of the control object and the detected value of the sensor, a proportional arithmetic unit configured to produce a proportional-component drive signal on the basis of the deviation provided from the deviation arithmetic unit, an integral arithmetic unit configured to calculate an integral value of the deviation provided from the deviation arithmetic unit and to produce an integral-component drive signal on the basis of the integral value, a derivative arithmetic unit configured to calculate a derivative value of the deviation provided from the deviation arithmetic unit and to produce a derivative-component drive signal on the basis of the derivative value, and a drive-signal output unit configured to output the drive signals provided from the integral arithmetic unit, the proportional arithmetic unit, and the derivative arithmetic unit to a drive circuit for driving the actuator. At least an integral gain ki of the integral arithmetic unit is in a range satisfying 0.1 V/rad·s≦ki≦4200 V/rad·s.

A camera apparatus according to an embodiment of the invention includes a control circuit that includes a desired-value arithmetic unit configured to calculate a desired value of a control object, a sensor configured to detect a value indicating a state of an actuator that is used to displace the control object, a deviation arithmetic unit configured to calculate a deviation of the control object from the desired value on the basis of the desired value of the control object and the detected value of the sensor, a proportional arithmetic unit configured to produce a proportional-component drive signal on the basis of the deviation provided from the deviation arithmetic unit, an integral arithmetic unit configured to calculate an integral value of the deviation provided from the deviation arithmetic unit and to produce an integral-component drive signal on the basis of the integral value, a derivative arithmetic unit configured to calculate a derivative value of the deviation provided from the deviation arithmetic unit and to produce a derivative-component drive signal on the basis of the derivative value, and a drive-signal output unit configured to output the drive signals provided from the integral arithmetic unit, the proportional arithmetic unit, and the derivative arithmetic unit to a drive circuit for driving the actuator. At least an integral gain ki of the integral arithmetic unit is in a range satisfying 0.1 V/rad·s≦ki≦4200 V/rad·s.

According to an embodiment of the invention, the integral gain ki of the control parameters is set to be in a range from 0.1 to 4200, and a gain in the low frequency region of frequency characteristics is improved.

As described above, according to an embodiment of the invention, it is possible to realize a stable control system in which a slow oscillation is suppressed in a low-frequency region, in a light-load control system for objects such as an iris or an ND filter, by appropriately setting parameters such as an integral gain.

### BRIEF DESCRIPTION OF THE DRAWINGS

FIG. 1 is a graph showing example frequency characteristics of a control system;

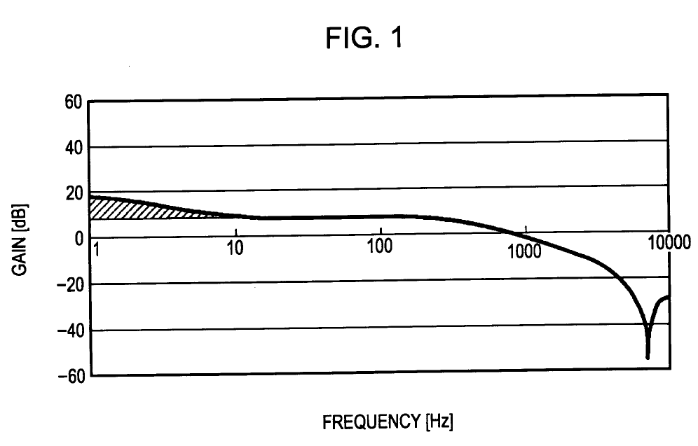

FIG. 2 includes diagrams for explaining jitter;

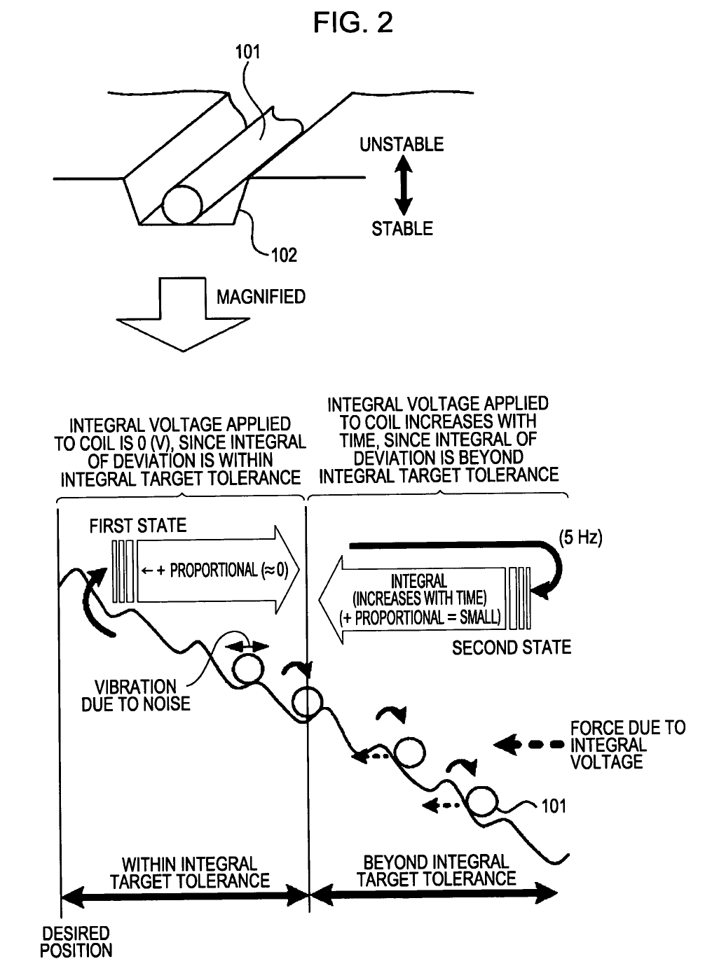

FIGS. 3A and 3B are schematic diagrams showing structures of a camera apparatus according to an embodiment of the present invention, where FIG. 3A shows a state in which an iris aperture is made to be small, and FIG. 3B shows a state in which the iris aperture is made to be large;

FIG. 4 is a block diagram showing an example internal configuration of a control block according to the embodiment of the invention;

FIG. 5 is a flowchart showing operations of a controller according to the embodiment of the invention.

FIGS. 6A and 6B are graphs showing integral voltage versus time, where FIG. 6A shows the integral voltage of an existing example, and FIG. 6B shows the integral voltage according to the embodiment of the invention;

FIG. 7 is a block diagram showing another example of an internal configuration of a control block according to the embodiment of the invention;

FIG. 8 is a schematic diagram showing an evaluation system configuration; and

FIG. 9 is a graph showing the frequency characteristics of control objects according to the embodiment of the invention.

### DESCRIPTION OF THE PREFERRED EMBODIMENTS

An exemplary embodiment according to the invention will be described below with reference to the accompanying drawings.

Embodiments described below are specific preferred examples of embodiments for implementing the invention, and hence include several technically desirable restrictions. However, the description of embodiments below does not limit the invention to the embodiments unless otherwise stated. Therefore, for example, materials and the amounts used, process times, the order of processes, numerical conditions of parameters described below, and the like are merely desirable examples. Furthermore, the dimensions, shapes, and positional relationships in the drawings, for example, are also merely examples and are schematically illustrated.

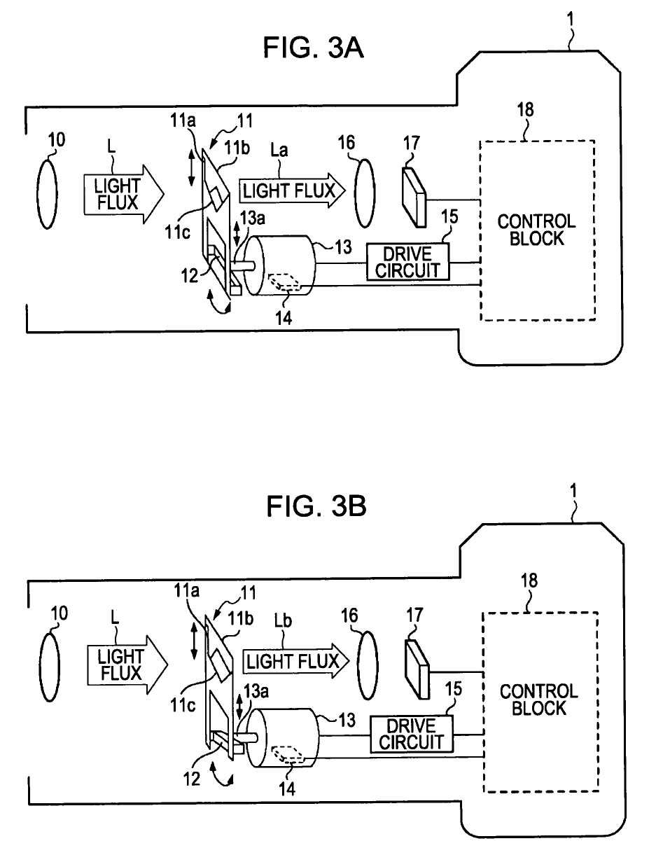

FIGS. 3A and 3B show schematic structures of a camera apparatus according to an embodiment. FIG. 3A shows a state in which an iris aperture is made to be small, and FIG. 3B shows a state in which the iris aperture is made to be large. A camera apparatus 1 is an example in which the camera apparatus 1 is applied to a still camera. Note that a mechanism for controlling an ND filter, which is substantially the same as that for controlling an iris, is omitted in the description below.

The camera apparatus 1 is provided, inside its lens barrel, with a lens 10, an iris 11, an arm 12, a meter (actuator) 13, a Hall sensor 14, a drive circuit 15, a lens 16, and an image pickup element 17.

The iris 11 includes two diaphragm blades 11a and 11b and the arm 12, which transmits the power of the meter 13 to the diaphragm blades 11a and 11b. The arm 12 is coupled to a rotation axle 13a of the meter 13. The meter 13 includes within it a wound leaf spring, for example, and detects a rotational angle of the meter 13 with the Hall sensor 14. The meter 13 is an example of an actuator including a rotational device.

Each of the diaphragm blades 11a and 11b has a cut-out portion to make the amount L of incident light be a desired amount. The cut-out portions form an aperture 11c. By changing the rotation angle of the meter 13, the diaphragm blades 11a and 11b are slid in opposite directions, and hence, the size of the aperture 11c is changed. It is assumed that the meter 13 utilizes force exerted by the leaf spring. Thus, the amount of light supplied to the lens 16 is controlled by changing the rotation angle of the meter 13.

Referring to FIGS. 3A and 3B, as an example, to adjust the amount of light L that is received by the image pickup element 17 through the lenses 10 and 16 to La or Lb, the rotation angle of the meter 13 is controlled such that the size of the aperture 11c becomes a size shown in FIG. 3A or a size shown in FIG. 3B.

In the iris 11, the rotation angle of the meter 13 is proportional to the size of the aperture 11c, and a detected signal corresponding to the rotation angle of the meter 13 is output from the Hall sensor 14. In other words, the Hall sensor 14 is used as a position sensor of the iris 11. The servo control of the size of the aperture 11c is made possible by observing the detected signal of the Hall sensor 14.

When the meter 13 rotates, the Hall sensor 14 detects a magnetic field corresponding to a rotation angle of the meter 13, and accordingly outputs an analog electric signal (detected signal). Thus, the output signal of the Hall sensor 14 enables the movement of a control object, such as an iris, to be detected. A predetermined reference voltage Vcc is applied to the Hall sensor 14. The direction and amount of the rotation of the meter 13 are controlled by means of a control signal (drive signal) that is provided through a digital-to-analog (D/A) converter (not shown) from a control block 18, which performs computing and control operations for PID control. On the other hand, the control block 18 receives from the Hall sensor 14 a detected signal, which has an amplitude of several hundred millivolts, for example.

The control block 18 is a PID controller that operates on the basis of a deviation of a detected value provided by the Hall sensor 14 from a desired value of the meter 13.

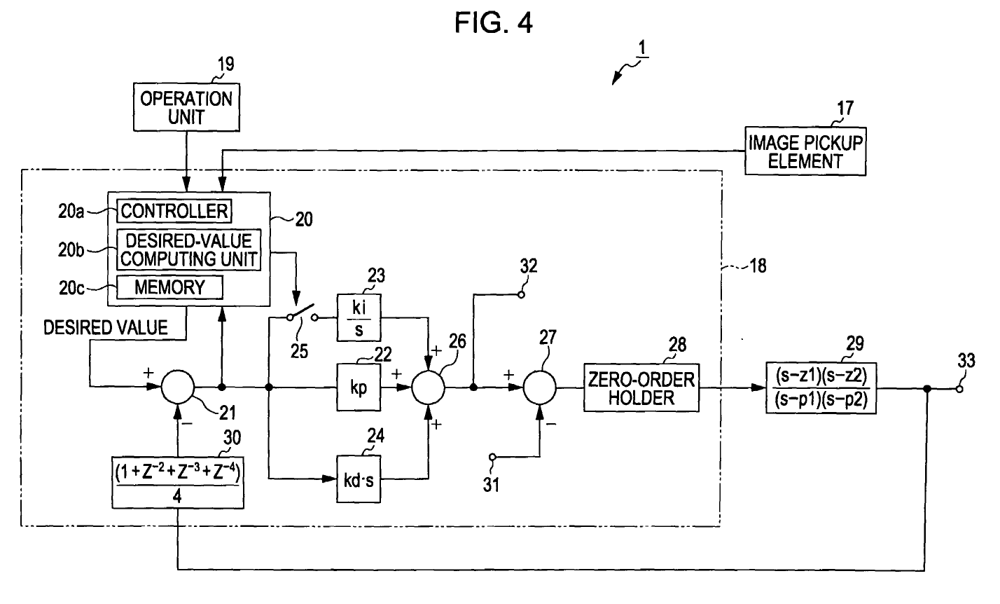

FIG. 4 is a block diagram showing an example internal configuration of the control block 18 according to the embodiment of the invention.

The control block 18 includes a microcomputer 20 having a processor and a memory, a subtractor 21, a proportional arithmetic unit 22, an integral arithmetic unit 23, a derivative arithmetic unit 24, an adder 26, a subtractor 27, a zero-order holder 28, and a four-term average filter 30 formed on a specified substrate.

The microcomputer 20, which includes a controller 20a, a desired-value computing unit 20b, and a memory 20c, controls the entirety of the control block 18 and performs arithmetic operations.

The controller 20a controls each unit or component of the control block 18 and performs arithmetic operations. For instance, the controller 20a processes an electric signal (image signal) that is input from the image pickup element 17, and performs predetermined control and arithmetic operations on the basis of an operation signal that is input from an operation unit 19 of the camera apparatus 1. The controller 20a also controls turning on and off of a switch 25 provided in front of the integral arithmetic unit 23. For instance, the controller 20a turns off the switch 25 when a feedback value becomes equal or nearly equal to a desired value.

The desired-value computing unit 20b calculates a desired value (control signal) that corresponds to an optimum size of the aperture 11c of the iris 11 on the basis of an image brightness signal output from the image pickup element 17, and provides the control signal to the subtractor 21. Alternatively, the desired-value computing unit 20b calculates a desired value (control signal) that corresponds to a user-specified size of the aperture 11c of the iris 11 on the basis of an operation signal that is output from the operation unit 19 operated by a user, and provides the control signal to the subtractor 21.

The memory 20c is formed of a semiconductor memory, for example. The memory 20c stores a table indicating the optimum size of the aperture 11c of the iris 11 versus the brightness signal level of an image, a table indicating desired value (control signal) versus the size of the aperture 11c of the iris 11, a desired value calculated by the desired-value computing unit 20b, and the like.

The subtractor 21, an example of a deviation arithmetic unit, receives a desired value that is calculated by the desired-value computing unit 20b of the microcomputer 20 and a detected value (current position data of the meter 13) of the Hall sensor 14 through the four-term average filter 30 described below. The subtractor 21 subtracts the detected value from the desired value, and the result (deviation) is provided to the microcomputer 20, the proportional arithmetic unit 22, the integral arithmetic unit 23 through the switch 25, and the derivative arithmetic unit 24. It should be noted that the subtractor 21 may be replaced with an adder to which a negated output signal of the four-term average filter 30 is provided.

The proportional arithmetic unit 22 multiplies the detected deviation from the desired value, provided from the subtractor 21, by a proportional gain (proportional constant) kp.

When the switch 25 is in the on state, the integral arithmetic unit 23 calculates an integral value of the detected deviation from the desired value, provided from the subtractor 21, and multiplies the integral value by an integral gain (integral constant) ki, or multiplies the deviation by ki/s in s-domain. Here, s means s-plane (s-domain) and can be replaced with jω, i.e., s=jω.

The derivative arithmetic unit 24 calculates a derivative value of the detected deviation from the desired value, provided from the subtractor 21, and multiplies the derivative value by a derivative gain (derivative constant) kd, or multiplies the deviation by kd·s in s-domain. It should be noted that the integral operation causes a backward phase shift of π/2, and the derivative operation causes a forward phase shift of π/2.

The adder 26 adds the calculation results of the proportional arithmetic unit 22, the integral arithmetic unit 23, and the derivative arithmetic unit 24. The adder 26 provides the calculated sum to the subtractor 27 and an output terminal 32.

The subtractor 27 subtracts an external low-frequency disturbance signal that is input through an input terminal 31 from the calculation result of the adder 26. It should be noted that the subtractor 27 can be replaced with an adder. In this case, a signal that is input through the input terminal 31 is negated.

The zero-order holder 28 holds a value obtained at a sampling point for the duration of a sampling interval. The adder 26, the subtractor 27, and the zero-order holder 28, though not limited to these, are examples of a drive-signal output unit.

A control object 29 in the embodiment is the meter 13, which moves the arm 12 of the iris 11, and its transfer function is expressed by, for example, a quadratic function (s−z1)(s−z2)/(s−p1)(s−p2), where z1, z2, p1, and p2 are constants determined in accordance with a control object. The output from the control object 29, namely a detected value of the Hall sensor 14, is provided to the four-term average filter 30 and an output terminal 33.

The four-term average filter 30 calculates and provides to the subtractor 21 the average of detected values of the current, the previous, the second previous, and the third previous samples. Here, Z means a Z-plane, and Z is transformed to s by, for example, a bilinear transform; and Z⁻¹, Z⁻², and Z⁻³ respectively mean the previous, the second previous, and the third previous samples of the detected values. For instance, for a sampling interval of 1 ms, the four-term average filter 30 calculates the average of the current, 1 ms previous, 2 ms previous, and 3 ms previous detected values. This will alleviate the influence of noise and the like added to an output signal of the Hall sensor 14.

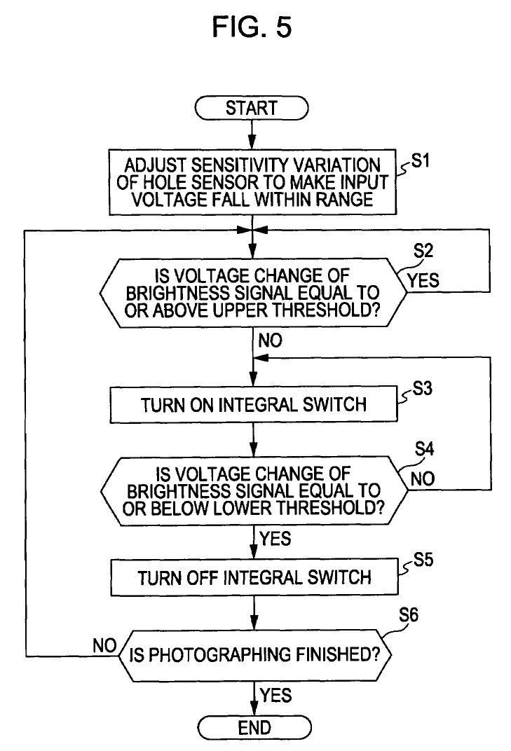

Referring now to a flowchart of FIG. 5, the operation of the controller 20a will be described below.

In step S1, the controller 20a adjusts the variation in sensitivity of the Hall sensor 14, so that the voltages of detected values of the Hall sensor 14 corresponding to attribute size of the aperture 11c fall within a predetermined range. Then the flow proceeds to step S2.

In step S2, the controller 20a determines whether changes in voltage of a signal (called a “Hall output” hereafter) that is output from the Hall sensor 14 are negligible, that is to say the magnitude of the change in Hall output is equal to or above a predetermined upper threshold. When the magnitude of the change in voltage is equal to or above the upper threshold, the change in voltage of the Hall output is continued to be kept monitored.

In step S3, when the magnitude of the change in voltage of the Hall output is determined to be below the upper threshold, the controller 20a turns on the switch 25. The flow proceeds to step S4 after this.

In step S4, the controller 20a determines whether or not the magnitude of a change in voltage of the Hall output from the Hall sensor 14 is equal to or below a predetermined lower threshold. When the magnitude of the change in voltage of the Hall output is above the lower threshold, the flow goes back to step S3 to keep the switch 25 turned on. When the magnitude of the change in voltage is equal to or below the lower threshold, the flow proceeds to step S5. Note that the predetermined lower threshold may be set to substantially zero, for example.

In step S5, the controller 20a turns off the switch 25. The flow proceeds to step S6 after this.

In step S6, the controller 20a determines whether photographing is finished or not. When photographing is not finished, the flow goes back to step S2. When photographing is finished, the steps for turning on/off of the switch 25 end.

Through the sequence of processing steps performed by the controller 20a, the integral arithmetic unit 23 is activated by turning on the switch 25 when the magnitude of the change in voltage of the Hall output is larger than a threshold. This allows the integral arithmetic unit 23 to operate and appropriately control the control object 29 only when necessary. Hence, power consumption can be limited since unnecessary operations of the integral arithmetic unit 23 are avoided.

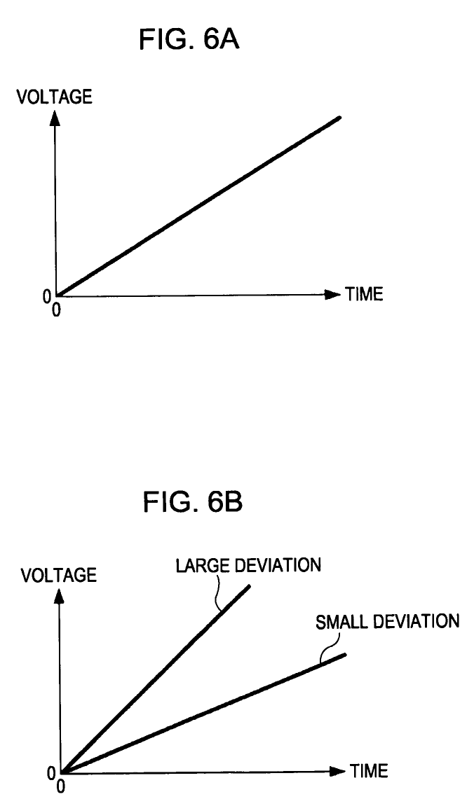

FIGS. 6A and 6B are graphs showing integral voltage versus time. FIG. 6A shows the voltage of an existing integral component, and FIG. 6B shows the voltage of an integral component according to the embodiment of the invention. In each of these figures, the horizontal and vertical axes show time and voltage, respectively.

In the existing technology, as shown in FIG. 6A, when a detected value deviates from a desired value, a voltage is applied at a fixed rate of change irrespective of the amount of the deviation until the deviation becomes zero, where only the direction (+or −) in which the iris (control object) is to be moved is determined. In other words, at a certain time, a voltage corresponding to an area (integral value) defined by the line showing a rate of voltage change and the time axis is applied. In this case, appropriate control is difficult since the rate of change of the applied voltage is not changed.

FIG. 6B is a graph showing the voltage of the integral arithmetic unit 23 in the embodiment. In the integral arithmetic unit 23, when a detected value deviates from a desired value, a rate of change of the applied voltage is determined on the basis of the amount of the deviation of the detected value from the desired value. A voltage is applied that increases at a rate of change that depends on the amount of the deviation until the deviation becomes zero, in the direction (+or −) in which the iris (control object) is determined to be moved. The graph in FIG. 6B shows a case in which two straight lines respectively correspond to a small deviation and a large deviation. In accordance with the amount of deviation, a voltage corresponding to an area (integral value) defined by the respective line showing a rate of voltage change and the time axis is applied at a certain time. For instance, an applied voltage is increased at a large rate of change when the detected value deviates from a desired value by a large amount, whereas an applied voltage is increased at a small rate of change when the detected value deviates from a desired value by a small amount. Thus, when the amount of deviation, namely the accumulated deviation proportional to the absolute value of the deviation, is reflected in the rate of change of the applied voltage, a quick response is realized. It should be noted that the arrangements of the straight lines in FIG. 6B are determined on the basis of the integral gain ki.

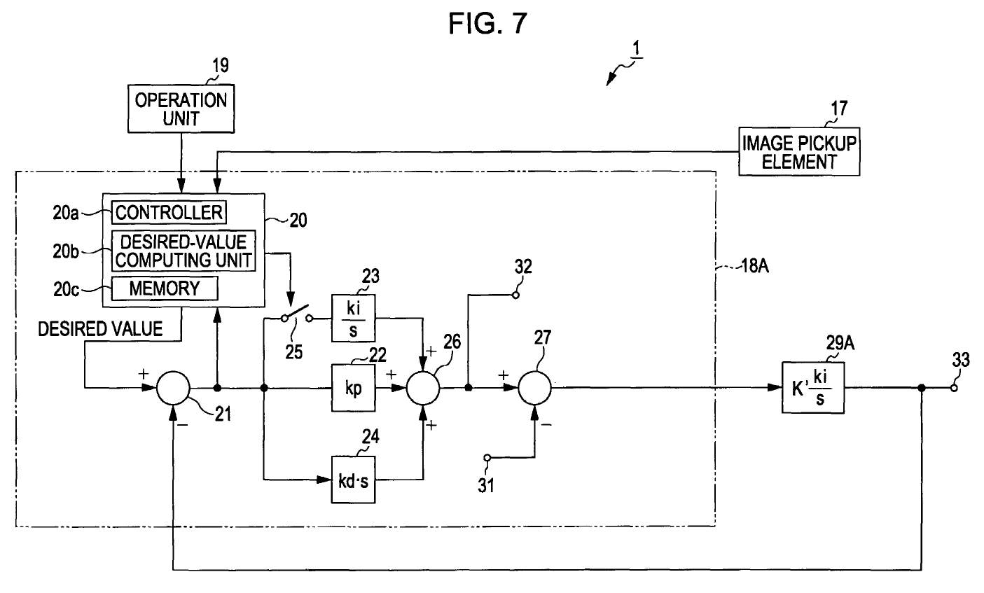

Next, description will be made as to how control parameters are obtained using a pole placement equation. For ease of explanation, pole placement is discussed for a simplified continuous system of the internal configuration of the control block shown in FIG. 4, where the control object is assumed to have a quadratic function, and the zero-order holder 28 and the four-term average filter 30 are removed. FIG. 7 is a block diagram showing the simplified control block.

Referring to FIG. 7, a control block 18A has a configuration in which the zero-order holder 28 and the four-term average filter 30 have been removed from the control block 18 of FIG. 4. The transfer function of a control object 29A is assumed to be K′·ki/s. Here, components of FIG. 7 that correspond to those of FIG. 4 are denoted by the same numerals, and their detailed descriptions are omitted.

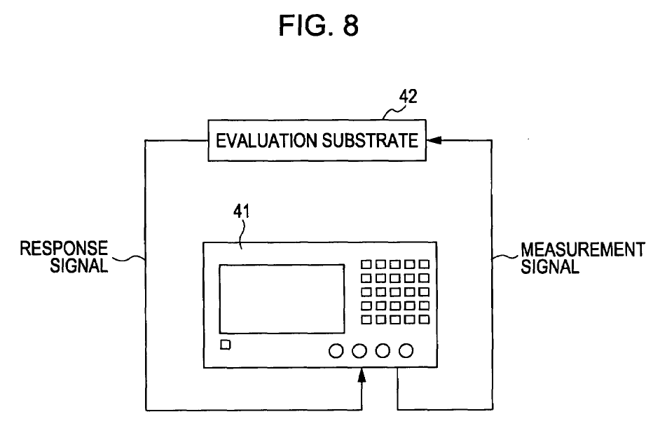

FIG. 8 is a schematic diagram showing an evaluation system for evaluating the characteristics of the above described control system shown in FIG. 4 and the control system shown in FIG. 7.

Referring to FIG. 8, a measurement signal corresponding to an external disturbance signal is supplied to an evaluation substrate 42 and the frequency characteristics of the response signal are measured and analyzed by fast Fourier transform (FFT) using an FFT analyzer 41. The camera apparatus 1 including the control block 18 described above corresponds to the evaluation substrate 42, and the detected value of the Hall sensor 14 is input to the FFT analyzer 41 through A/D conversion.

The output of the Hall sensor 14 is adjusted such that the variation in sensitivity of the Hall sensor 14 is negligible at the FFT analyzer 41. This is similar to the adjustment of the output at the camera apparatus 1 as was described above. For instance, adjustment is made, according to the instructions of a control software program, such that the Hall sensor 14 outputs predetermined voltages, after A/D conversion, for the maximum size and minimum size of the aperture 11c of the iris 11 located on a light path. Then, after normalizing the sensitivity of the Hall sensor 14, the aperture 11c of the iris 11 is set half open, that is, the output of the Hall sensor 14 is fixed to, for example, a value in the middle of the voltages corresponding to the maximum and minimum sizes of the aperture 11c.

A control system analyzer (HP-35670A) manufactured by Yokokawa Hewlett-Packard, Ltd. is used as the FFT analyzer 41, although it is not limited to this. A sine wave having an amplitude of about 100 mVₒₚ is applied as the measurement signal to the input of the evaluation substrate 42 so that the diaphragm blades 11a and 11b of the iris 11 are not mechanically limited even at the maximums of their movement.

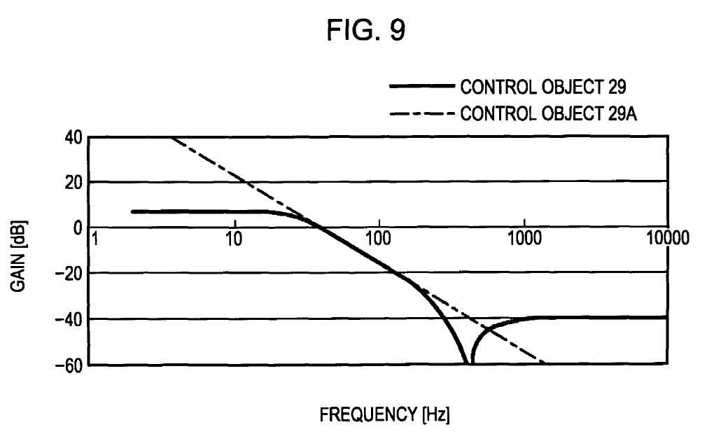

The coefficient K′ of the transfer function of the control object 29A shown in FIG. 7 is set such that the gain in mid to high frequency region matches that of FIG. 4. FIG. 9 shows the frequency characteristics of the control object 29 shown in FIG. 4 and the control object 29A shown in FIG. 7.

Referring to FIG. 9, the horizontal and vertical axes show frequency using a logarithmic scale and gain, respectively. When the coefficient K′ in the transfer function of the control object 29A is 60000, the two frequency characteristics coincide relatively well in a frequency range of roughly from 40 to 100 Hz.

The transfer function G(s) of the control system shown in FIG. 7, from the input terminal 31 to the output terminal 33, is given by Equation (2), which comes from Equation (1):

$$\begin{matrix}G ( s ) = \frac{( kp + kds + \frac{ki}{s} ) \frac{{K}^{′}}{{s}^{2}}}{1 + \frac{{K}^{′}}{{s}^{2}} ( kp + kds + \frac{ki}{s} )} & ( 1 ) \\ = \frac{{K}^{′} ( kd \cdot {s}^{2} + kps + ki )}{{s}^{3} + {K}^{′} kd \cdot {s}^{2} + {K}^{′} kp \cdot s + {K}^{′} ki} & ( 2 )\end{matrix}$$

Letting the denominator of Equation (2) be equal to the denominator of Equation (3) representing the poles, pole placement equations (4) to (6) are obtained:

$$\begin{matrix}{G}_{ref} ( s ) = \frac{{K}^{′} ( kd \cdot {s}^{2} + kps + ki )}{{( s + p )}^{3}} & ( 3 ) \\ kp = \frac{3 {p}^{2}}{{K}^{′}} & ( 4 ) \\ kd = \frac{3 p}{{K}^{′}} & ( 5 ) \\ ki = \frac{{p}^{3}}{{K}^{′}} & ( 6 )\end{matrix}$$

The relationship between the proportional gain kp and a constant a (proportional gain in decimal notation) is given by Equation (7), and the relationship between the derivative gain kd and a constant b (derivative gain in decimal notation) is given by Equation (8):

kp=0.05566×a (7)

kd=6.494×10⁻⁴×b (8)

The transfer function of the control object has a second order time lag. A damping coefficient ζ is known as the evaluation index of the transient response of this second order time lag system. The closer to 1 the damping coefficient ζ is, the more stable the control system is. However, a control system with ζ=1, although stable, is inferior in terms of responsiveness to a system with ζ=0.8, for example. Hence, in order to configure a stable and highly responsive control system, an appropriate value should be chosen for the damping coefficient. The proportional gain, integral gain, and derivative gain should be appropriately determined on the basis of this appropriate value of the damping coefficient.

In the case of the small and light-load meter 13 in the embodiment, the coefficient in front of the constant a in Equation (7) is in the range 0.05 to 0.06, for example, and is chosen to be 0.05566 in the embodiment. Likewise, the coefficient in front of the constant b in Equation (8) is in the range 6.0×10⁻⁴ to 7.0×10⁻⁴, for example, and is chosen to be 6.494×10⁻⁴ in the embodiment. These values are roughly determined in accordance with a device (actuator).

Assuming a pole of 100 Hz and hence letting p=100×2π, for example, Equations (4) to (6) give the following results: proportional coefficient kp=19.7; integral gain ki=4128 V/rad·s; and derivative gain kd=0.0314 V·s/rad. Equations (7) and (8) give the following: a=35; and b=48.

Assuming a pole of 80 Hz and hence letting p=80×2π, for example, the following results are obtained: proportional coefficient kp=12.6; integral gain ki=2117 V/rad·s; and derivative gain kd=0.0251 V·s/rad. In this case, a=226 and b=39, and therefore, Gp (positional gain)=E2H and Gv (velocity gain)=27H.

Thus, when Gp and Gv are set to be Gp=E2H and Gv=27H, and the integral gain ki is increased to about 4200 V/rad·s beyond 0, a PID control system having a servo band of about 80 Hz and a function of suppressing external disturbance by performing integration can be thought to be realized. In this case it is desirable that the proportional gain kp satisfy 1≦kp≦20 and the derivative gain kd satisfy 0.001 V·s/rad≦kd≦0.1 V·s/rad.

It is desirable that the values of the above-described parameters be determined with consideration of nonlinearity of the control block and by judging its stability.

As has been described above, image jitter (a slow vibration of about 5 Hz or below) can be suppressed or removed according to the embodiment of the invention.

A phenomenon in which the amount of light received by an image pickup element changes stepwise can also be lessened or removed. Hence, the brightness of a subject image captured by the image pickup element can be smoothly changed.

Furthermore, various problems pertaining to friction caused by displacement of control objects can be solved.

The embodiment described above is an example of lessening image jitter by appropriately setting parameters in a digital control system. However, a control system having a similar advantage can also be realized using analog circuits.

In the embodiment described above, a still camera was chosen as an example of camera apparatuses to which the invention can be applied. However, the invention can, of course, be applied to a video camera or the like.

It should be understood by those skilled in the art that various modifications, combinations, sub-combinations and alterations may occur depending on design requirements and other factors insofar as they are within the scope of the appended claims or the equivalents thereof.

What is claimed is:

1. A control circuit comprising:
a desired-value arithmetic unit configured to calculate a desired value of a control object;
a sensor configured to detect a value indicating a state of an actuator that is used to displace the control object;
a deviation arithmetic unit configured to calculate a deviation of the control object from the desired value on the basis of the desired value of the control object and the detected value of the sensor;
a proportional arithmetic unit configured to produce a proportional-component drive signal on the basis of the deviation provided from the deviation arithmetic unit;
an integral arithmetic unit configured to calculate an integral value of the deviation provided from the deviation arithmetic unit and to produce an integral-component drive signal on the basis of the integral value;
a derivative arithmetic unit configured to calculate a derivative value of the deviation provided from the deviation arithmetic unit and to produce a derivative-component drive signal on the basis of the derivative value; and
a drive-signal output unit configured to output the drive signals provided from the integral arithmetic unit, the proportional arithmetic unit, and the derivative arithmetic unit to a drive circuit for driving the actuator,
wherein at least an integral gain ki of the integral arithmetic unit is in a range satisfying 0.1 V/rad·s≦ki≦4200 V/rad·s.

2. The control circuit according to claim 1,
wherein the control object is an iris or a neutral density filter.

3. The control circuit according to claim 2,
wherein a proportional gain kp of the proportional arithmetic unit and a derivative gain kd of the derivative arithmetic unit are respectively in ranges satisfying 1≦kp≦20 and 0.001 V·s/rad≦kd≦0.1 V·s/rad.

4. A camera apparatus comprising:
a control circuit,
wherein the control circuit includes
a desired-value arithmetic unit configured to calculate a desired value of a control object,
a sensor configured to detect a value indicating a state of an actuator that is used to displace the control object,
a deviation arithmetic unit configured to calculate a deviation of the control object from the desired value on the basis of the desired value of the control object and the detected value of the sensor,
a proportional arithmetic unit configured to produce a proportional-component drive signal on the basis of the deviation provided from the deviation arithmetic unit,
an integral arithmetic unit configured to calculate an integral value of the deviation provided from the deviation arithmetic unit and to produce an integral-component drive signal on the basis of the integral value,
a derivative arithmetic unit configured to calculate a derivative value of the deviation provided from the deviation arithmetic unit and to produce a derivative-component drive signal on the basis of the derivative value, and
a drive-signal output unit configured to output the drive signals provided from the integral arithmetic unit, the proportional arithmetic unit, and the derivative arithmetic unit to a drive circuit for driving the actuator,
wherein at least an integral gain ki of the integral arithmetic unit is in a range satisfying 0.1 V/rad·s≦ki≦4200 V/rad·s.
